(19) United States
(12) Patent Application Publication
(10) Pub. No.: US 2022/0016844 A1
(43) Pub. Date: Jan. 20, 2022

(54) Build Material Spreading Apparatuses for Additive Manufacturing

(71) Applicant: HEWLETT-PACKARD DEVELOPMENT COMPANY, L.P., Spring, TX (US)

(72) Inventors: Fernando JUAN JOVER, Sant Cugat del Valles (ES); Gerard MOSQUERA DONATE, Sant Cugat del Valles (ES); Berta ROIG GRAU, Sant Cugat del Valles (ES); Francesc MELIA SUNE, Sant Cugat del Valles (ES)

(73) Assignee: HEWLETT-PACKARD DEVELOPMENT COMPANY, L.P., Spring, TX (US)

(21) Appl. No.: 17/294,680

(22) PCT Filed: Apr. 30, 2019
(86) PCT No.: PCT/US2019/029878

§ 371 Date: May 17, 2021

(51) Int. Cl. B29C 64/393; B33Y 10/00; B33Y 30/00; B33Y 50/02; B29C 64/218

(52) U.S. Cl. CPC B29C 64/393; B33Y 10/00; B29C 64/218; B33Y 50/02; B33Y 30/00

(57) ABSTRACT

This build material spreading apparatus for additive manufacturing, includes a movable spreader, a build material dispenser, and a controller to calibrate the amount of build material needed to form a layer. The controller controls the build material dispenser to dispense a predetermined amount of build material. The controller controls the movable spreader to spread the dispensed build material to form a layer. The controller determines an amount of build material remaining after spreading. The controller modifies, based on the determined amount of remaining build material, the predetermined amount of build material to be subsequently provided by the build material dispenser.

### BACKGROUND

Additive manufacturing devices, sometimes called 3D printers, produce print parts by adding successive layers of material from a series of cross sections which are joined together to create the final part. In some additive manufacturing machines, a build material spreading apparatus forms layers all along a build area. Heat may be used to selectively fuse together the particles in each of the successive layers to form the cross sections of the final part. Manufacturing may proceed layer by layer until the object is complete.

### BRIEF DESCRIPTION OF THE DRAWINGS

Various examples will be described below by referring to the following figures, in which:

FIG. 1 is a schematic view of an additive manufacturing device according to an example of the present disclosure.

FIG. 2 is a sideview of a build material spreading apparatus of the example additive manufacturing device from FIG. 1.

FIG. 3 is an isometric view of a build material spreading apparatus according to another example of the present disclosure.

FIG. 4 is a sideview of the example build material spreading apparatus of FIG. 3.

FIG. 5 is a cross-sectional view taken along the line V-V in FIG. 4.

FIG. 6 is a flowchart of an example build material spreading method of the present disclosure.

FIG. 7 illustrates an example of the image taken by the camera of the example build material spreading apparatus of FIGS. 3 to 5.

FIG. 8 illustrates an example construction implemented to the example image of FIG. 7.

FIG. 9 illustrates another example construction implemented to the example image of FIG. 7.

### DETAILED DESCRIPTION

In one example, a build material dispenser is to provide build material to spread so as to form a layer. In order to ensure that each layer of build material is formed correctly, more material than needed is generally provided to be spread to form each layer, the material remaining after formation of the layer being generally directed into an overflow chamber.

In one example, a controller calibrates the amount of build material needed to form a subsequent layer taking into account an excess amount of build material dispensed to form a layer already spread over the build area. This may decrease overflows of build material, in such a way that the additive manufacturing machines may become able to do larger jobs with the same supply chamber size and smaller overflow chambers.

In one example, a camera allows taking a picture of the layer on the build area. Analysis of the picture taken by the camera allows translating it into an amount of material needed for a subsequent layer.

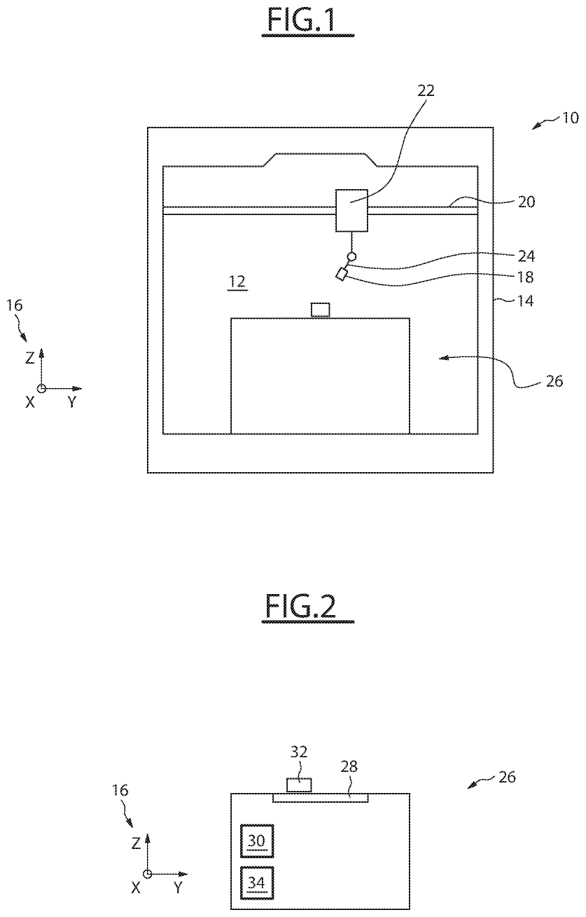

In one example, which is depicted on FIG. 1, an additive manufacturing device 10 includes a printing chamber 12 delimited by a printing structure 14.

In this example, a direct orthonormal vector basis 16 is attached to the printing structure 14. The vector basis 16 may include a vector X, a vector Y and a vector Z. When the printing structure 14 is arranged on a plane horizontal surface, the vector Z is vertically, upwards oriented.

The additive manufacturing device 10 may include a heat source 18 located within the printing chamber 12. In this example, the heat source 18 is able to move with respect to the printing structure 14 along several, e.g. three, translation degrees of freedom and several, e.g. three, rotation degrees of freedom. To do so, the additive manufacturing device 10 may include a rod 20 extending along the direction of the vector Y, a box 22 movable with respect to the rod 20 in translation along the direction of the vector Y, an arm 24 holding the heat source 18 and movable with respect to the box 22 in rotation in the plane perpendicular to the vector X.

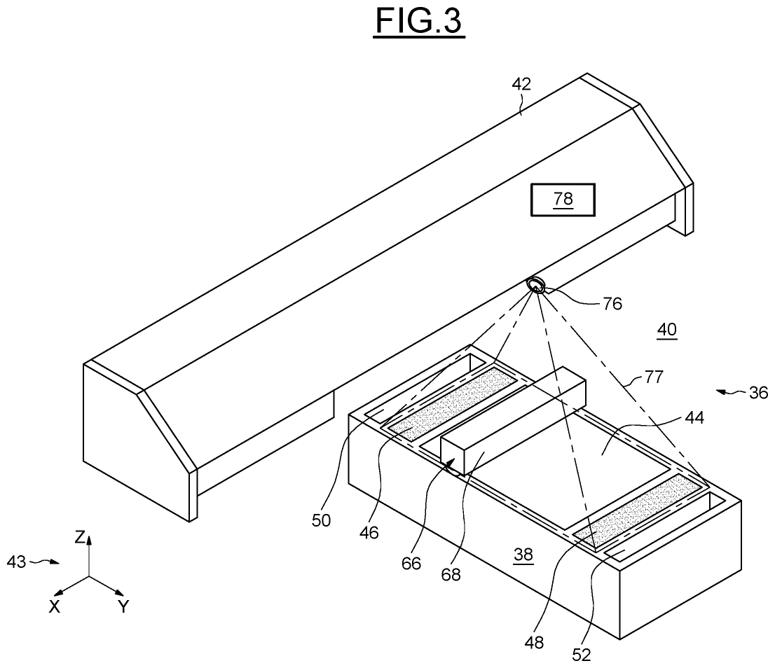

The additive manufacturing device 10 may include a build material spreading apparatus 26. FIG. 2 is a sideview of the build material spreading apparatus 26.

Referring to FIG. 2, the build material spreading apparatus 26 may include a build area 28, a build material dispenser 30, a movable spreader 32 and a controller 34. In this example, the build material dispenser 30 may contain a large amount of build material. The movable spreader 32 may move in translation above the build area 28 along the direction of the vectors X and Y. In this example, the build material may be powdered material.

By virtue of this arrangement, prior to the formation of a layer on the build area 28, the build material dispenser 30 may provide the movable spreader 32 with a predetermined volume of build material. The movable spreader 32 may move in translation above the build area 28 so as to form a first layer on the build area 28. Then, the controller 34 may determine an excess amount of build material dispensed to form the first layer, that is, an amount of build material remaining after the spreading operation. The controller 34 may calculate an amount of build material needed to form a second layer taking into account the excess amount of build material dispensed to form the first layer, and may pilot the build material dispenser 30 to provide the movable spreader 32 with a modified amount of build material. Hence, the controller 34 may calibrate the predetermined amount of build material needed to form the second layer.

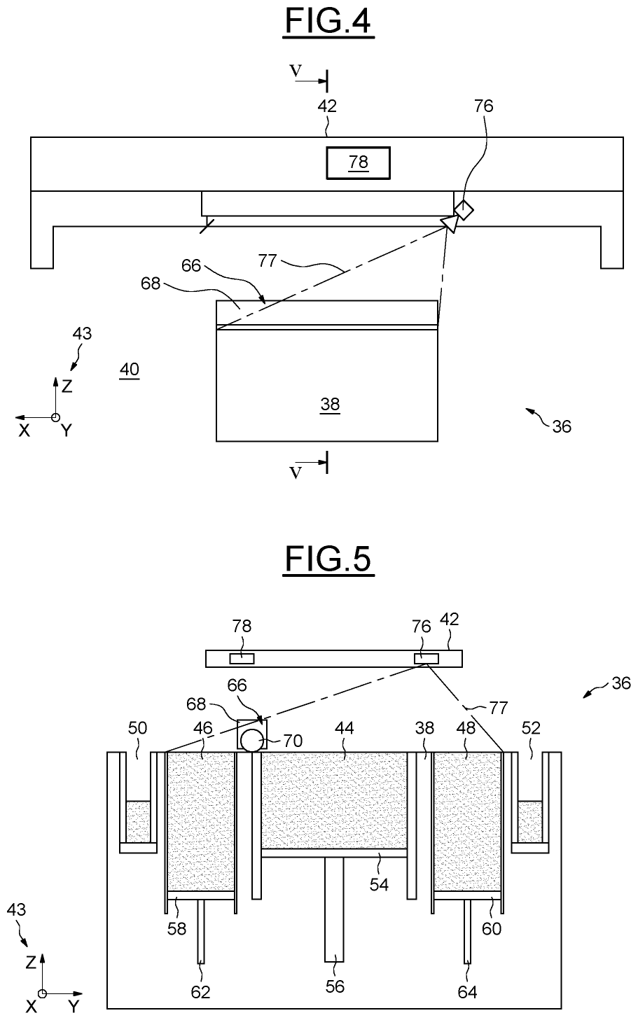

In another example, which is depicted on FIGS. 3 to 5, a build material spreading apparatus 36 includes a housing 38 enclosed within a printing chamber 40. The printing chamber 40 may be partially delimited by an elongated wall 42. In another example, the build chamber may be separate from the build material spreading apparatus.

In the example of FIGS. 3 to 5, a direct orthonormal vector basis 43 is attached to the elongated wall 42. The vector basis 43 may include a vector X, a vector Y and a vector Z. When the elongated wall 42 is arranged parallel to the vector X, the vector Z is vertically, upwards oriented.

Unless indicated otherwise, the words “upwards”, “downwards”, “upper” and “lower” shall be understood as referring to the direction of the vertical, upwards oriented vector Z and the word “horizontal” means perpendicular to the vector Z.

The housing 38 may include a platform chamber 44, a first supply chamber 46, a second supply chamber 48, a first overflow chamber 50 and a second overflow chamber 52. In this example, the platform chamber 44 is located between the chambers 46 and 48, the first supply chamber 46 is located between the chambers 50 and 44, and the second supply chamber 48 is located between the chambers 44 and 52.

In the example of FIGS. 3 to 5, the platform chamber 44 is downwards delimited by a platform 54 (see FIG. 5). The platform 54 may move in translation along the direction of the vector Z with respect to the housing 38, for instance by means of a jack 56. The first and second supply chambers 46 and 48 may be downwards delimited by respective pistons 58 and 60 which may move in translation along the direction of the vector Z. The pistons 58 and 60 may be actuated by means of respective jacks 62 and 64.

The build material spreading apparatus 36 may include a spreader 66. The spreader 66 can include a casing 68 and a roller 70 accommodated within the casing 68. The roller 70 may be a cylinder rotatable about an axis parallel to the vector X. The spreader 66 may be movable with respect to the housing 38 in horizontal translation above the chambers 46, 44 and 48. The spreader 66 may be movable in translation about the direction of the vectors X and Y between the first and second overflow chambers 50 and 52. The roller 70 may be movable in rotation about its own axis with respect to the casing 68.

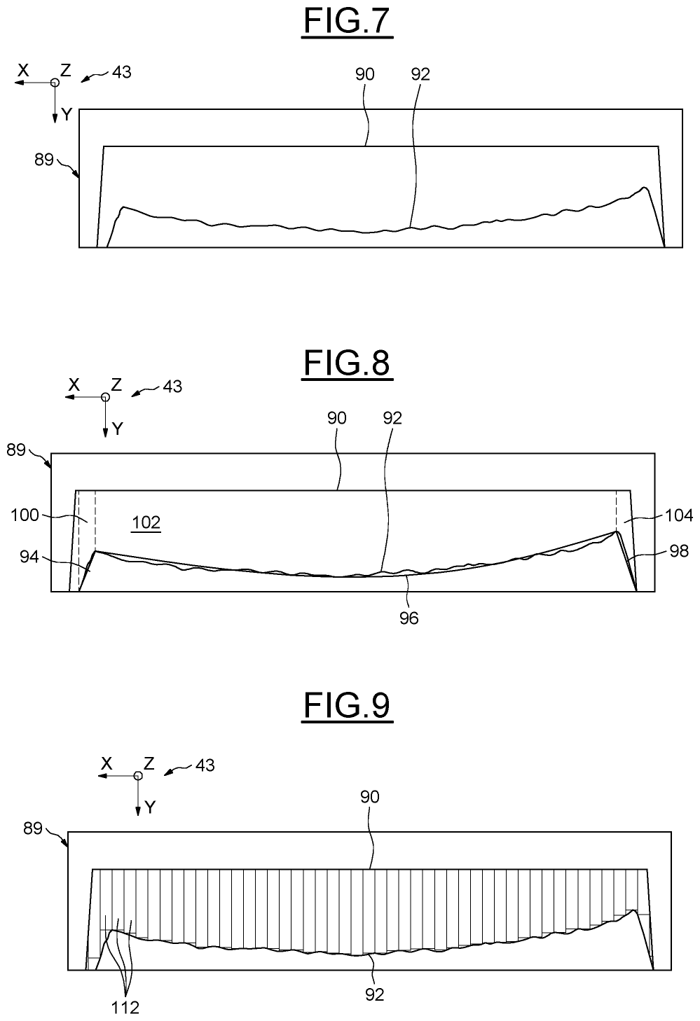

In this example, the build material spreading apparatus 36 includes a camera 76. The camera 76 may be attached to a printing structure of an additive manufacturing device, for instance to the wall 42. The camera 76 may be located in one corner of the printing chamber 40. Hence, there is no need of a lens and the risk of collision with other subsystems of the additive manufacturing device is decreased. The scope of the camera 76 is indicated on FIGS. 3 to 5 with the dashed lines 77. In this example, the camera 76 has a field of vision encompassing the upper surface of the chambers 46, 44 on 48. Hence, the camera 76 may take pictures of layers spread over the upper surface of the chambers 46, 44 and 48. FIG. 7, which will be described later, illustrates a portion of an example of such a picture.

The build material spreading apparatus 36 may include a controller 78. The controller 78 may be in data communication with the camera 76, with the jack 62 and with the jack 64.

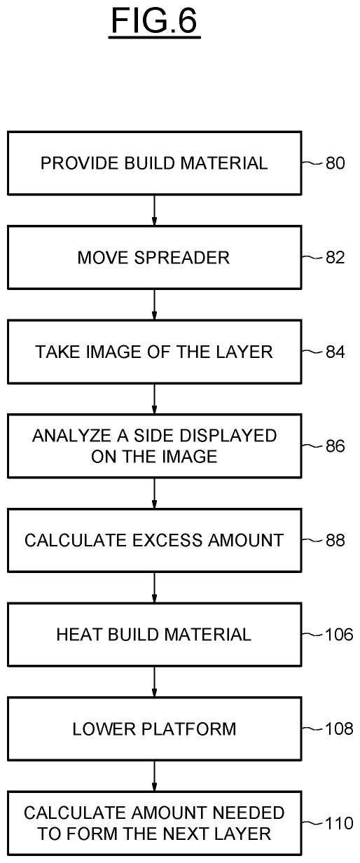

In one example, which is depicted on FIG. 6, a build material spreading method using the example build material spreading apparatus 36 of FIGS. 3 to 5 will now be detailed. The example method of FIG. 6 may be implemented each time a layer is formed. During an initial state of the example method, the spreader 66 is located between the first overflow chamber 50 and the first supply chamber 46.

The example method may include, at block 80, controlling the jack 62 to move the piston 58 upwards. As a result, an amount, e.g. 12 grams, of build material is provided from the first supply chamber 46 to an area being between the spreader 66 and the platform chamber 44. The build material used in the example method of FIG. 6 may be any suitable type of build material, such as a plastic, a metal, a ceramic or the like. During the first step 80, the jack 64 may also move the piston 60 downwards. The displacement of the piston 60 along the direction of the vector Z may be of a height h_{predetermined}.

The example method may include, at block 82, controlling the spreader 66 to move into the second overflow chamber 52. By doing so, a layer is formed over the platform chamber 44 and the second supply chamber 48. Meanwhile, extra build material may be spread over the second supply chamber 48.

The example method may include, at block 84, taking an image of the layer formed at block 82. Extra build material spread at block 82 may form a portion 89 of the layer which is adjacent to the position of the spreader 66 at the end of the displacement of the spreader 66 at block 82. A portion 89 of an example image taken is depicted on FIG. 7.

The example method may include, at block 86, analyzing one side of the overflow powder as captured shown on the image taken at block 84. The side which is analyzed may be the side of the layer formed at block 82 which is adjacent to the spreader 66 in its position at the end of its displacement at block 82. In other words, when the spreader 66 moves from the chamber 50 to the chamber 52, the side which is analyzed may be the side of the layer formed at block 82 which is adjacent to the second overflow chamber 52.

The example method may include, at block 88, calculating an excess amount a_{excess} of build material dispensed.

To calculate the amount a_{excess}, the example method may use a portion of the image taken at block 84. In one example, depicted on FIG. 7, the portion 89 of the image taken at block 84 shows a straight line 90 corresponding to an edge of the platform chamber 44. The portion 89 may also include a curved line 92 corresponding to the side of the layer formed at block 82.

According to an example of a geometrical construction, which is depicted on FIG. 8, the curved line 92 may be split up into a straight line 94, a parabolic line 96 and a straight line 98. The controller 78 may then divide the area between the lines 90 and 92 in a first area 100 delimited, along the direction of the vector Y, by the lines 90 and 94, a second area 102 delimited, along the direction of the vector Y, by the lines 90 and 96, and a third area 104 delimited, along the direction of the vector Y, by the lines 90 and 98. The controller 78 may then calculate the surface areas A₁₀₀, A₁₀₂ and A₁₀₄ corresponding respectively to the areas 100, 102 and 104. Then, the controller 78 may calculate the excess surface area A_{excess} of build material as the sum of the surface areas A₁₀₀, A₁₀₂ and A₁₀₄.

In the example method, the controller 78 may calculate the excess volume V_{excess} of build material as the product of the surface area A_{excess} by a predetermined height, which could be the height h_{predetermined}.

In the example method, the controller 78 may calculate the excess amount a_{excess} by multiplying the calculated volume V_{excess} by the volumetric mass density p of the build material.

Referring to FIG. 6, the example method may include, at block 106, heating the layer formed at block 82. The heat source 18 may be used to heat the layer. Particles may be fused together so as to form a cross section of the final part. If the build material used in the example method of FIG. 6 is a metal, heating the layer may not be implemented.

The example method may further include, at block 108, lowering the platform 54. To do so, the jack 56 may be actuated in such a way that it lowers the platform 54 of the height h_{predetermined}.

The example method may include, at block 110, calculating the amount a_{next_layer} of build material needed to form the next layer. To do so, the controller 78 may calculate the amount a_{next_layer} by subtracting the excess amount a_{excess} from a predetermined constant amount A. For example, the amount A may be within a range 9 grams to 15 grams.

In the example method of FIG. 6, the steps 80, 82, 84, 86, 88, 106, 108 and 110 may then be repeated in order to form the next layer. For instance, the step 80 may be implemented using the second supply chamber 48 and the step 82 may be implemented by moving the spreader 66 into the first overflow chamber 50. In the example method of FIG. 6, controlling the jack 62 to move the piston 58 upwards is implemented in such a way that the amount of build material provided to the spreader 66 equals the amount a_{next_layer} determined just previously at block 110.

In another example of a geometrical construction of the portion 89, which is shown on FIG. 9, the area located between the lines 90 and 92 is divided into a plurality of rectangular areas 112. Each rectangular area 112 may have a side indistinguishable from the line 90 and a side located between the lines 90 and 92 and having one point in common with the line 92. In the example construction of FIG. 9, the dimension e₁₁₂ of the rectangular areas 112 along the direction of the vector X is the same for all the rectangular areas 112.

With the geometrical construction of FIG. 9, a step of calculating the excess amount a_{excess} may include calculating the surface area of each rectangular area 112. To do so, for each rectangular area 112, the vertical length I₁₁₂ may be measured by the camera 76 and multiplied by the dimension e₁₁₂. The surface area A_{excess} may then be calculated as the sum of the surface areas of all the rectangular areas 112. Then, the excess amount a_{excess} may be obtained by calculating the excess volume V_{excess} in the same way as in the example method of FIG. 6 and the example geometrical construction of FIG. 8.

In the geometrical construction of FIG. 9, the value of the dimension e₁₁₂ may be modified in order to adjust the accuracy of the determination of the surface area A_{excess}. Namely, the dimension e₁₁₂ may be decreased in order to determine more accurately the dimension e₁₁₂.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A build material spreading apparatus for additive manufacturing, including
a movable spreader to spread build material over a build area,
a build material dispenser to provide the movable spreader with build material, and
a controller to calibrate the amount of build material needed to form a layer to be spread over the build area, wherein the controller is to:
control the build material dispenser to dispense a predetermined amount of build material;
control the movable spreader to spread the dispensed build material to form a layer of build material on the build area;
determine an amount of build material remaining after spreading;
modify, based on the determined amount of remaining build material, the predetermined amount of build material to be subsequently provided by the build material dispenser.

2. The build material spreading apparatus of claim 1, further including a camera to visualize at least partially the layer of build material, wherein the controller is to use an image issued by the camera in order to determine an amount of remaining build material.

3. The build material spreading apparatus of claim 2, wherein the controller is to:
use an image issued by the camera to measure a surface area of a portion of the layer;
calculate a volume by multiplying the surface area determined by a predetermined height;
infer the amount of remaining build material from the volume calculated.

4. The build material spreading apparatus of claim 2, wherein the camera is to visualize an area of the layer which is distant from the build area.

5. The build material spreading apparatus of claim 2, wherein the camera is to visualize a side of the layer of build material.

6. The build material spreading apparatus of claim 5, wherein the side is adjacent to a position of the movable spreader at the end of the formation of the layer.

7. The build material spreading apparatus of claim 5, wherein the controller is to:
split up the side into at least two segments,
for each segment, measure a surface area of a part of the layer being adjacent to the segment;
determine a surface area delimited by the side by calculating the sum of the surface areas associated to the segments of the side.

8. A build material spreading apparatus, including:
a supply volume to contain build material,
a spreader roller movable, and
a controller to adjust the quantity of build material needed to form a layer to be spread, wherein the controller is to:
pilot the supply volume to supply a predetermined quantity of build material;
move the spreader roller to form a layer of build material;
determine a quantity of build material in excess after formation of the layer of build material;
adjust, based on the determined quantity of build material in excess, the predetermined quantity of build material to be subsequently supplied by the supply volume.

9. The build material spreading apparatus of claim 8, wherein the supply volume includes a first supply chamber and a second supply chamber, the second supply chamber being opposite to the first supply chamber with respect to the platform, the spreader roller being movable between the first and second supply chambers.

10. The build material spreading apparatus of claim 9, further including a camera to visualize the layer of build material, wherein the controller is to process an image issued by the camera in order to determine the quantity of build material in excess after spreading.

11. The build material spreading apparatus of claim 10, wherein the camera is to visualize a region of the layer being adjacent to the first supply chamber or the second supply chamber.

12. The build material spreading apparatus of claim 10, including a first overflow chamber opposite to the platform with respect to the first supply chamber, a second overflow chamber opposite to the platform with respect to the second supply chamber, the camera having a field of view encompassing a first region located between the platform and the first overflow chamber and a second region located between the platform and the second overflow chamber.

13. The build material spreading apparatus of claim 12, wherein the controller is to infer the quantity of build material in excess from an image of a side of the layer, the side being adjacent to the second supply chamber when the spreader roller moves from the first supply chamber to the second supply chamber, the side being adjacent to the first supply chamber when the spreader roller moves from the second supply chamber to the first supply chamber.

14. A build material spreading method, including:
spreading a first layer of build material over a build area,
determining an excess amount of build material dispensed to form the first layer,
calculating an amount of build material needed to form a second layer as a function of the excess amount of build material dispensed to form the first layer,
piloting a build material dispenser to provide a movable spreader with the determined amount of build material, and
spreading a second layer of build material over the build area using the build material provided by the build material dispenser.

15. The build material spreading method of claim 14, wherein calculating the amount of build material needed to form the second layer includes applying the formula:
abm=A−eabm
wherein abm is the amount of build material needed to form the second layer, eabm is the excess amount of build material dispensed to form the first layer and A is a constant predetermined amount of build material.
